(19) United States
(12) Patent Application Publication
(10) Pub. No.: US 2013/0222247 A1
(43) Pub. Date: Aug. 29, 2013

(54) VIRTUAL KEYBOARD ADJUSTMENT BASED ON USER INPUT OFFSET

(71) Applicants: Eric Liu, Santa Clara, CA (US); Christian Collins, San Francisco, CA (US); Stefan J. Marti, Santa Clara, CA (US)

(72) Inventors: Eric Liu, Santa Clara, CA (US); Christian Collins, San Francisco, CA (US); Stefan J. Marti, Santa Clara, CA (US)

(21) Appl. No.: 13/408,347

(22) Filed: Feb. 29, 2012

(51) Int. Cl. G06F 3/02; G06F 3/041

(52) U.S. Cl. 345/168

(57) ABSTRACT

Example embodiments relate to adjustment of a virtual keyboard based on an offset of user input. In example embodiments, a computing device displays a virtual keyboard including a number of virtual keys selectable based on touch input. The device may then receive touch user inputs, where each user input corresponds to a selection of a particular virtual key. In response, the device may adjust a position and/or size of at least a given virtual key based on an offset with respect to the virtual key of each user input corresponding to the virtual key.

### BACKGROUND

Many computing devices now operate partly or exclusively based on touch input, which enables a user to interact with the device by directly manipulating a touch display. Given that interaction with a computing device generally requires the input of textual or numerical data, a typical touch-enabled device includes a virtual keyboard. Virtual keyboards display an array of keys in a user interface, such that the user may activate a key by providing touch input at the position of the key within the interface.

### BRIEF DESCRIPTION OF THE DRAWINGS

The following detailed description references the drawings, wherein:

FIG. 1 is a diagram of an example computing device that has outputted a virtual keyboard adjusted based on the offset of a user's input;

FIG. 2 is a block diagram of an example computing device for adjusting keys of a virtual keyboard based on the offset of a user's input;

FIG. 3 is a block diagram of an example computing device for adjusting keys of a virtual keyboard based on the offset of a user's input, where the computing device may adjust the keys individually or in groups;

FIG. 4 is a flowchart of an example method for adjusting keys of a virtual keyboard based on the offset of a user's input;

FIG. 5A is a flowchart of an example method for individually adjusting keys of a virtual keyboard based on the offset of a user's inputs for each key;

FIG. 5B is a flowchart of an example method for adjusting portions of a virtual keyboard based on the aggregate offset of the user's inputs for each portion;

FIGS. 6A-6D are diagrams of an example technique for adjusting the position of an individual virtual key based on an offset vector calculated for the key;

FIGS. 7A & 7B are diagrams of an example technique for adjusting the size of an individual virtual key based on a spatial distribution of the user inputs for the key;

FIGS. 8A-8C are diagrams of an example technique for adjusting the position and size of multiple virtual keys based on the offset and distribution of the inputs for each key;

FIGS. 9A-9C are diagrams of an example technique for adjusting the position of an entire virtual keyboard based on an aggregate offset of the inputs for the keyboard;

FIGS. 10A-10C are diagrams of an example technique for adjusting the position of multiple virtual keyboard portions based on an aggregate offset of the inputs for each portion;

FIGS. 11A-11D are diagrams of an example technique for adjusting the position of multiple virtual keys and rotating the virtual keyboard to fit the new position of the keys; and

FIGS. 12A-12C are diagrams of an example technique for adjusting the position of each column of virtual keys within a portion and rotating each portion to fit the adjusted columns.

### DETAILED DESCRIPTION

As detailed above, a virtual keyboard allows a user to provide keyed input using a touch-enabled display. While virtual keyboards provide a convenient mechanism for entering letters, numbers, and other characters, it is difficult for a user to touch type on a virtual keyboard in a manner similar to typing on a physical keyboard. In particular, while a physical keyboard provides tactile feedback in the form of keyboard curvature, discrete key caps, and key actuation clicks, touch displays generally lack these physical cues. As a result, the user's hands and fingers may drift while typing on a virtual keyboard. Typing using a virtual keyboard is therefore often significantly slower than using a physical keyboard and can result in an increase in typing errors.

Example embodiments disclosed herein address these issues by improving the ability of a user to quickly type using a virtual keyboard. For example, in some embodiments, a computing device displays a virtual keyboard that includes a number of virtual keys selectable based on touch input. The device may then receive a number of touch user inputs, where each user input corresponds to a selection of a particular virtual key. In response, the device may adjust the position of each virtual key, such that the adjusted position for a given key is based on the offset of the inputs for that key from a given position on the key (e.g., the center of the key).

In this manner, example embodiments disclosed herein dynamically shift the position of the keys on a virtual keyboard as a user types based on the accuracy of the user's typing. As a result, when using a larger form factor device, such as a tablet or touch All-in-One desktop, the user may type with both hands in a manner similar to touch typing on a keyboard, as the keys dynamically shift to accommodate drifting of the user's hands and fingers. Similarly, when using a smaller device, such as a mobile phone, the user may type quickly with his or her thumbs, while the keys shift to adjust for the user's typing accuracy. Thus, example embodiments provide for a virtual keyboard that increases typing speed and accuracy, while reducing user frustration.

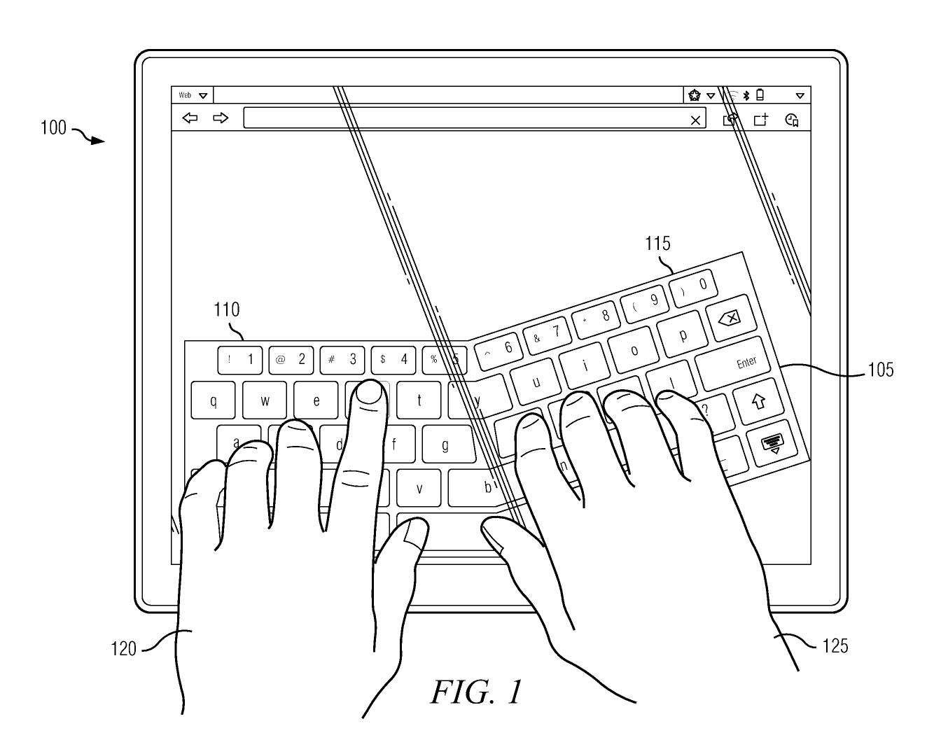

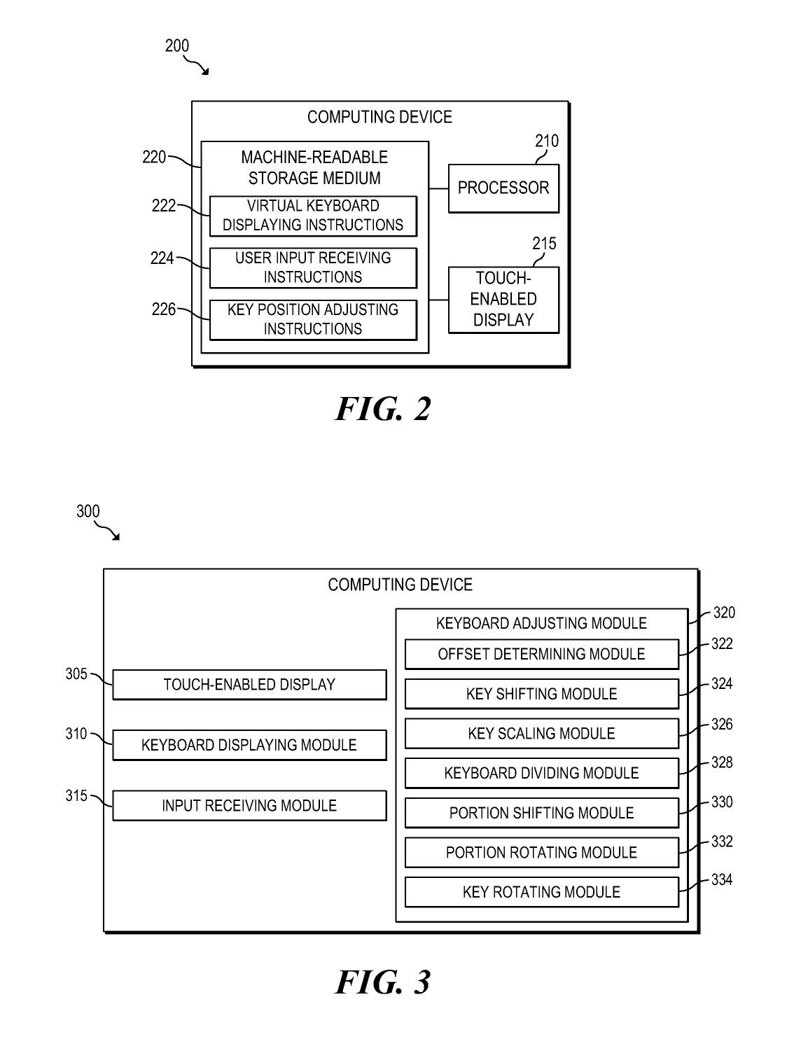

Referring now to the drawings, FIG. 1 is a diagram of an example computing device 100 that has outputted a virtual keyboard 105 adjusted based on the offset of a user's input. The following description of FIG. 1 provides an overview of example embodiments. Further implementation details regarding various embodiments are provided below in connection with FIGS. 2 through 12C.

As depicted in FIG. 1, a user is interacting with a display of a computing device 100, which, in this scenario, is a tablet computing device. The display has outputted a word processing application to which a user can provide input using a virtual keyboard 105. More specifically, the user is touch typing on virtual keyboard 105 using a left hand 120 and a right hand 125.

As detailed above, when touch typing on a virtual keyboard 105, a user's hands may drift away from the home position due to the lack of physical feedback from the virtual keyboard 105. For example, as illustrated in FIG. 1, the user's right hand 125 has drifted in an upward direction, while the user's left hand 120 has remained relatively stable with respect to the home position.

In response, device 100 has adjusted the halves 110, 115 of the keyboard 105 to account for the drift of the user's hands 120, 125. In particular, based on execution of processes described in further detail below, device 100 has shifted the keys and outline of right half 115 in an upper right direction, while rotating right half 115 roughly 45 degrees in a counterclockwise direction. As detailed below, the shift of the keys and outline of right half 115 may be based on the offset of the user's key presses from the corresponding keys. For example, device 100 may shift the position of the keys and/or keyboard based on the distance of the user's key presses from the center of each key. As a result, as the user's right hand 125 has shifted, right half 115 has shifted in a corresponding direction, enabling the user to continue touch typing with both hands while experiencing little to no reduction in typing speed and accuracy.

FIG. 2 is a block diagram of an example computing device 200 for adjusting keys of a virtual keyboard based on the offset of a user's input. As described in further detail below, a computing device 200 may generate and display a virtual keyboard on an available touch-enabled display 215. Based on the key selections received via touch-enabled display 215, computing device 200 may dynamically adjust the position of the virtual keyboard on display 215.

Computing device 200 may be, for example, a notebook computer, a desktop computer, an all-in-one system, a tablet computing device, a mobile phone, a set-top box, or any other computing device suitable for display of a user interface and virtual keyboard on a corresponding touch-enabled display 215. In the embodiment of FIG. 2, computing device 205 includes a processor 210 and a machine-readable storage medium 220.

Processor 210 may be one or more central processing units (CPUs), semiconductor-based microprocessors, and/or other hardware devices suitable for retrieval and execution of instructions stored in machine-readable storage medium 220. Processor 210 may fetch, decode, and execute instructions 222, 224, 226 to display a virtual keyboard and dynamically adjust the keyboard based on the offset of the user's inputs from the corresponding keys. As an alternative or in addition to retrieving and executing instructions, processor 210 may include one or more electronic circuits that include electronic components for performing the functionality of one or more of instructions 222, 224, 226.

Touch-enabled display 215 may be any combination of hardware components capable of outputting a video signal and receiving user input in the form of touch. Thus, touch-enabled display 215 may include components of a Liquid Crystal Display (LCD), Light Emitting Diode (LED) display, or other display technology for outputting a video signal received from processor 210 or another component of computing device 200. In addition, touch-enabled display 215 may include components for detecting touch, such as the components of, for example, a resistive, capacitive, surface acoustic wave, infrared, optical imaging, dispersive signal sensing, or in-cell system.

Machine-readable storage medium 220 may be any electronic, magnetic, optical, or other non-transitory physical storage device that contains or stores executable instructions. Thus, machine-readable storage medium 220 may be, for example, Random Access Memory (RAM), an Electrically Erasable Programmable Read-Only Memory (EEPROM), a storage device, an optical disc, and the like. As described in detail below, machine-readable storage medium 220 may be encoded with a series of executable instructions 222, 224, 226 for outputting a user interface including a virtual keyboard, receiving user selections of virtual keys, and adjusting the position of the virtual keys based on the offset of the user's key selections.

Virtual keyboard displaying instructions 222 may initially display a virtual keyboard on touch-enabled display 215. The virtual keyboard may include a plurality of keys selectable based on touch input provided to touch-enabled display 215. In addition, the virtual keyboard may be overlaid on a user interface of the operating system of device 200 or the user interface of an application executing within the operating system.

User input receiving instructions 224 may then receive a user input provided to touch-enabled display 215 that corresponds to a selection of a particular virtual key of the plurality of virtual keys. For example, as the user touches touch-enabled display 215, receiving instructions 224 may process the inputs to determine which key was selected with each touch input. For example, receiving instructions 224 may identify the coordinates of the touch and determine whether the coordinates are within the boundaries of a particular key. If so, receiving instructions 224 may determine that the touch is an activation of that particular key. In some implementations, if the touch is outside the boundaries of all keys, receiving instructions 224 may determine whether the touch was intended for a particular key. For example, receiving instructions 224 may determine which key is closest to the input, provided that the input is within a certain predetermined distance of the closest key.

Receiving instructions 224 may continue to receive and process input provided to touch-enabled display 215 while the virtual keyboard is displayed. As receiving instructions 224 receive selections of various keys on the virtual keyboard, receiving instructions 224 may provide data describing the inputs to key position adjusting instructions 226 for processing. For example, receiving instructions 224 may provide data for each key press that identifies the selected key and the coordinates of the corresponding touch input.

Key position adjusting instructions 226 may receive the data describing the inputs from receiving instructions 224 and, in response, dynamically adjust the position of the keys. For example, key position adjusting instructions 226 may adjust the position of the keys based on the offset of the user inputs from each corresponding key on the keyboard. The offset of each user input may represent a distance and direction of the key press from a predetermined position on the corresponding key, such as the center coordinate or a corner.

In some implementations, key position adjusting instructions 226 may adjust each key individually based on the offset of the inputs received specifically for that key. For example, upon receipt of data describing the input for a particular key, adjusting instructions 226 may calculate a vector representing the offset, as determined by connecting the predetermined point on the key with the position of the user input. Upon receipt of a given number of inputs for the key, adjusting instructions 226 may then calculate an average of all offset vectors for the particular key and adjust the position of the key based on the average offset. For example, adjusting instructions 226 may move the key in the direction of the offset by a distance equal to the calculated magnitude. In some implementations, to ensure that the boundary of a particular key does not overlap the boundary of an adjacent key, the adjustment of each key may be limited to a predetermined distance from the home position of the key or limited based on the position of the adjacent keys.

As a specific example of the adjustment of an individual key, suppose the user has activated the “J” key 10 times while typing using the virtual keyboard. In response, key position adjusting instructions 226 may generate 10 vectors, where each vector connects the center coordinate of the “J” key with the corresponding user input. Adjusting instructions 226 may then calculate the average of the 10 vectors and shift the position of the “J” key in the direction of the average offset vector by the magnitude of the vector up to a given maximum shift.

In other implementations, key position adjusting instructions 226 may adjust groups of keys together based on the offsets of the inputs received for the group of keys in the aggregate. For example, rather than adjusting each key individually, adjusting instructions 226 may move the position of the entire keyboard based on the average offset vector of the inputs for the keyboard as a whole.

Regardless of whether keys are adjusted individually or in groups, key position adjusting instructions 226 may, in some implementations, adjust the position of each key based on a predetermined number of most recent user inputs received. As one example, adjusting instructions 226 may only adjust each key or group of keys after reaching a given number of inputs. As a specific example, adjusting instructions 226 may wait until 10 inputs have been received, move the key or group of keys based on the inputs and then wait until receiving another 10 inputs before adjusting the keys. Alternatively, adjusting instructions 226 may adjust each key or group of keys every time a key selection is received. For example, adjusting instructions 226 may utilize a floating window, such that, when a key input is received, adjusting instructions 226 utilize the last N inputs to adjust the position of the keys. In addition, in some implementations, the inputs may be weighted when calculating the average offset, such that the most recent inputs have higher weights than the earlier inputs.

FIG. 3 is a block diagram of an example computing device 300 for adjusting keys of a virtual keyboard based on the offset of a user's input, where the computing device may adjust the keys individually or in groups. Computing device 300 may be any computing device suitable for display of a user interface including a virtual keyboard.

Computing device 300 may include touch-enabled display 305, which, as with touch-enabled display 215, may be any combination of hardware components capable of outputting a video signal and receiving user input in the form of touch. Additionally, computing device 300 may include a number of modules 310, 315, and 320-334 for providing the adjustable virtual keyboard functionality described herein. Each of the modules may include a series of instructions encoded on a machine-readable storage medium and executable by a processor of computing device 300. In addition or as an alternative, each module may include one or more hardware devices including electronic circuitry for implementing the functionality described below.

Keyboard displaying module 310 may initially output a virtual keyboard including a plurality of keys selectable based on user input provided to touch-enabled display 305. Displaying module 310 may overlay the virtual keyboard on an existing user interface displayed by device 300, such that the user may provide keyed input to the displayed user interface. Additional details regarding keyboard displaying module 310 are provided above in connection with virtual keyboard displaying instructions 222 of FIG. 2.

Input receiving module 315 may receive user input provided to touch-enabled display 305 that corresponds to a selection of a particular virtual key. In particular, in response to a touch input, input receiving module 315 may determine which key has been selected and provide data describing the selection to keyboard adjusting module 320. The provided data may include, for example, an identification of the selected key and the coordinates of the corresponding touch input. Additional details regarding input receiving module 315 are provided above in connection with user input receiving instructions 224.

Keyboard adjusting module 320 may then dynamically adjust the position of the keys based on analysis of the input data provided by input receiving module 315. The technique used for adjusting the position of the keys may vary by embodiment. For example, in some implementations, keyboard adjusting module 320 may utilize key shifting module 324 and key scaling module 326 to shift and resize each key individually. In other implementations, keyboard adjusting module may initially divide the keyboard into portions (e.g., halves) using keyboard dividing module 328, adjust the keys in groups using portion shifting module 330 and portion rotating module 332, and then rotate the keys in each portion using key rotating module 334. Further details regarding each module are provided below.

Offset determining module 322 may initially receive data describing the user's key selections from input receiving module 315. In response, determining module 322 may determine the offset for each of the user's selections. For example, as described above in connection with key position adjusting instructions 226 of FIG. 2, the offset for a given key may represent a distance and direction of the user's touch input from a predetermined position on the key, such as the center coordinate of the key.

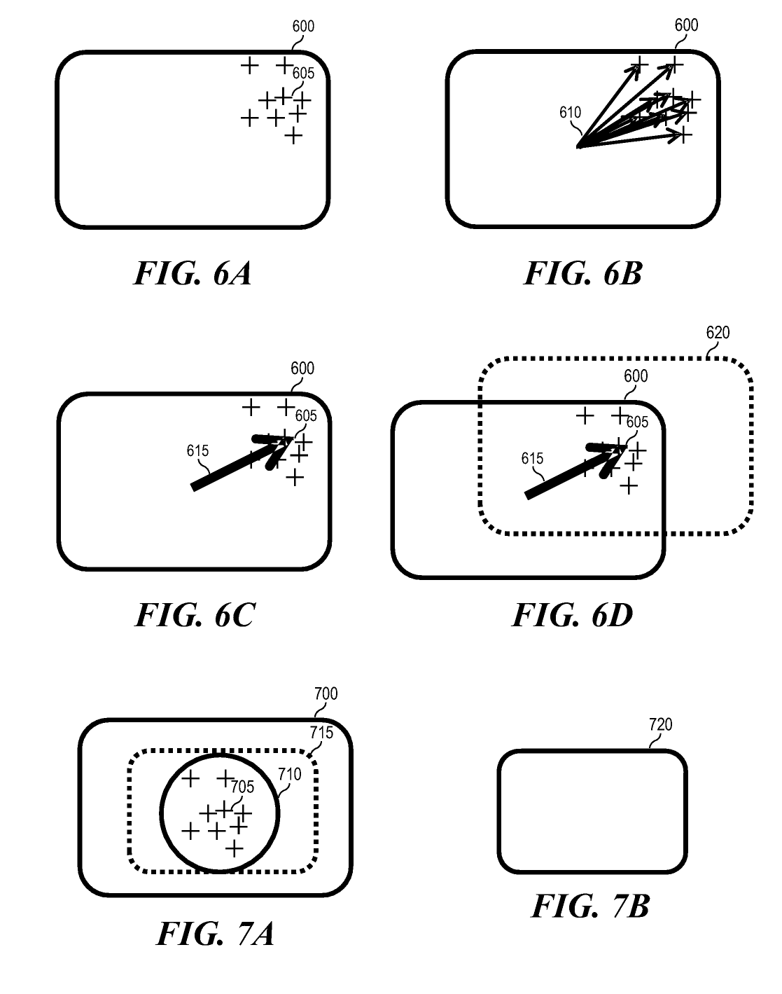

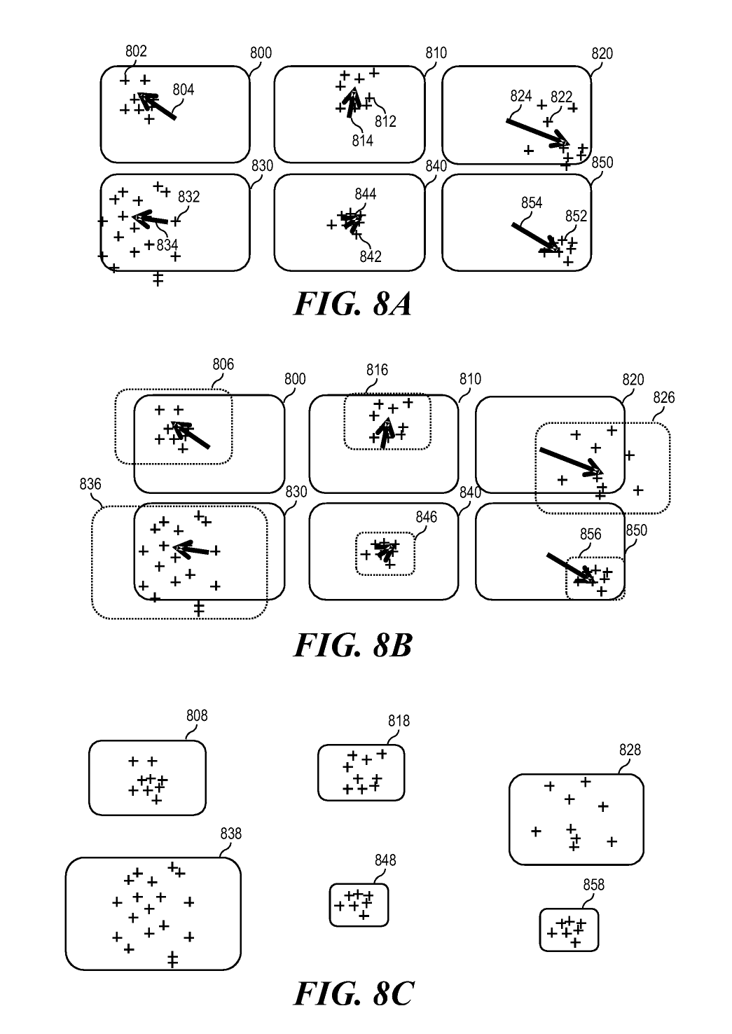

In implementations in which the keys are to be adjusted individually, offset determining module 322 may then provide the offset data to key shifting module 324 and key scaling module 326. In response, key shifting module 324 may individually adjust each key based on the offset data. For example, upon receiving a threshold number of offset values for a given key, key shifting module 324 may adjust the position of the key accordingly. As one example, key shifting module 324 may determine the average offset of the key presses for the given key and adjust the position of the key in the direction of the average offset. Examples of a technique for individually adjusting the position of keys are provided below in connection with FIGS. 6A-6D and FIGS. 8A-8C.

In addition to adjusting the position of the key, key scaling module 326 may also adjust the size of the key to account for the user's input accuracy. As one example, key scaling module 326 may identify the distribution of the user inputs for the key using the coordinates of the user's touches for the key, determine a size of the key that would encompass all of the user inputs, and increase or decrease the size of the key accordingly. In some implementations, key scaling module 326 may adjust the size of the key while maintaining the aspect ratio of the key. Examples of a technique for adjusting the size of a particular key are provided below in connection with FIGS. 7A, 7B, and 8A-8C.

Alternatively, in implementations in which the keys are to be adjusted in groups, keyboard dividing module 328 may initially divide the keyboard into groups of keys. As one example, keyboard dividing module 328 may split the keyboard into a left half and a right half, where each half of the keyboard includes approximately one half of the keys. As another example, keyboard dividing module 328 may divide the keyboard into four quadrants. Regardless of the number of portions to be used, shifting module 330 and rotating module 332 may move the keys included in a given portion as a group.

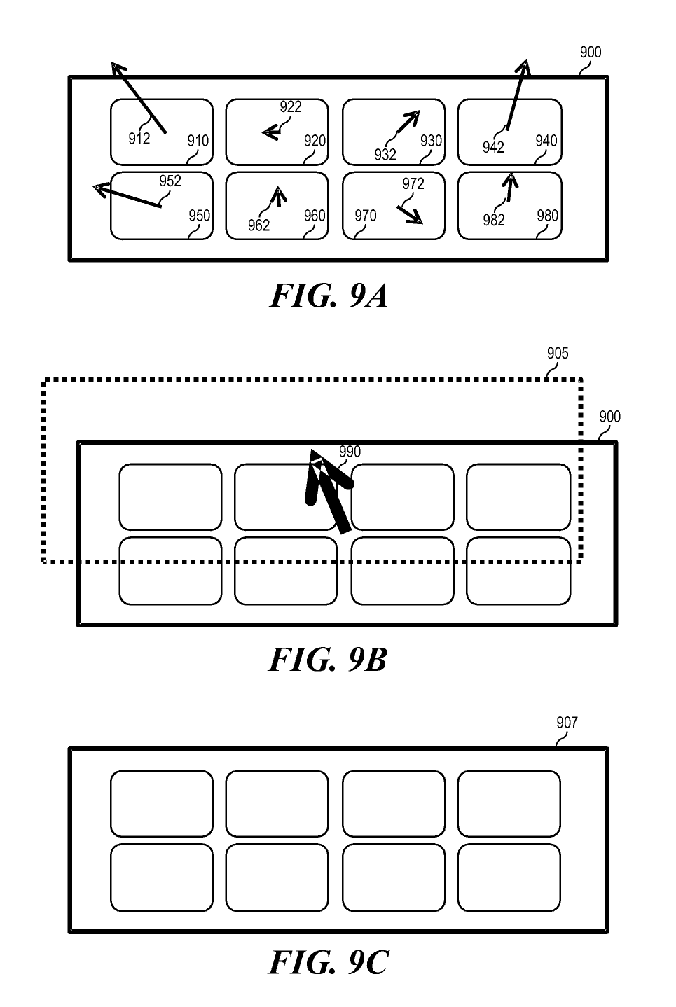

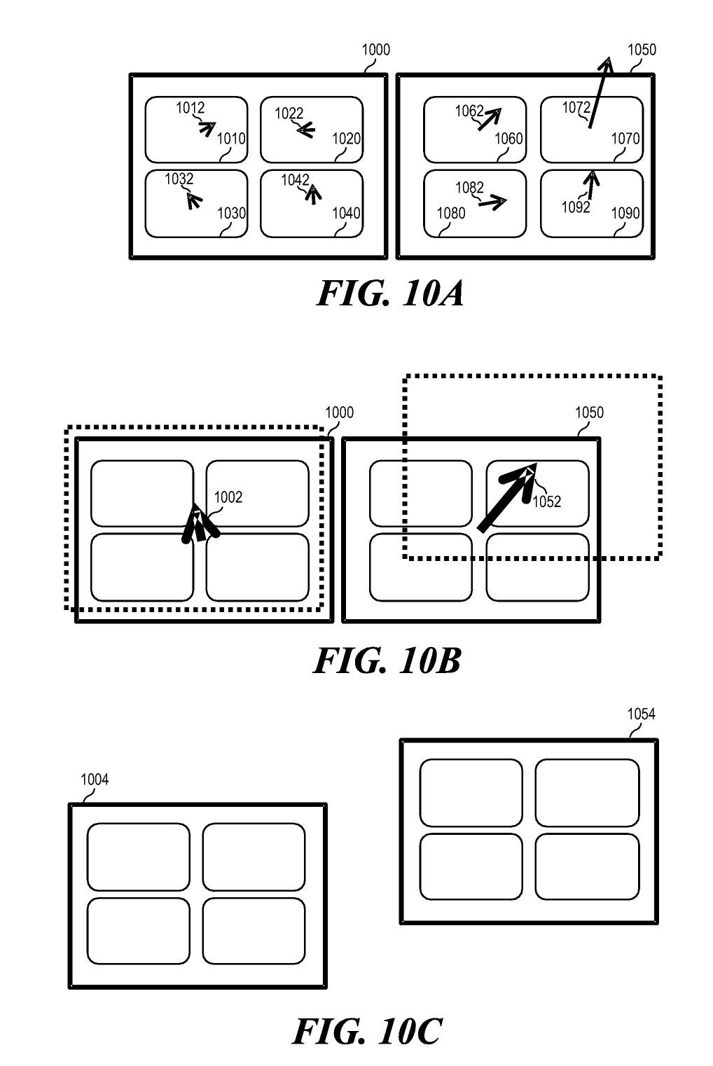

Thus, portion shifting module 330 may initially receive the offset data from offsetting determining module 322 and associate each offset with a corresponding portion of the keyboard. Portion shifting module 330 may then, for each portion, calculate the average offset for all inputs received for any keys in the particular portion. For example, portion shifting module 330 may sum all offset vectors for all key inputs received for the portion during a given period of time or for the last N inputs, and then calculate an average offset for the portion. Portion shifting module 330 may then shift the entire portion according to the average offset vector. By separately performing this procedure for each portion of the virtual keyboard, portion shifting module 330 may account for the user's typing accuracy in various portions of the keyboard. Examples of a technique for adjusting the position of a keyboard portion are provided below in connection with FIGS. 9A-9C and 10A-10C.

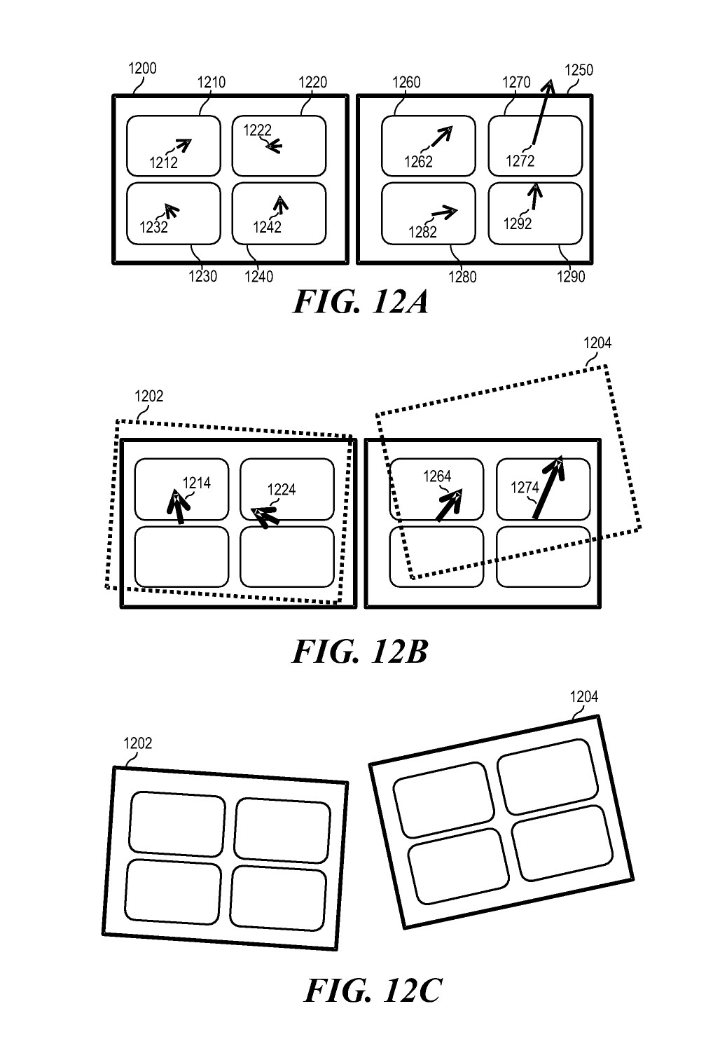

After portion shifting module 330 shifts the portions of the keyboard according to the input offsets, portion rotating module 332 may then rotate the portions accordingly. For example, portion rotating module 332 may rotate the outline of each portion of the keyboard so that the outline encompasses each of the keys in the portion. An example of a technique for rotating portions of a keyboard is provided below in connection with FIGS. 12A-12C.

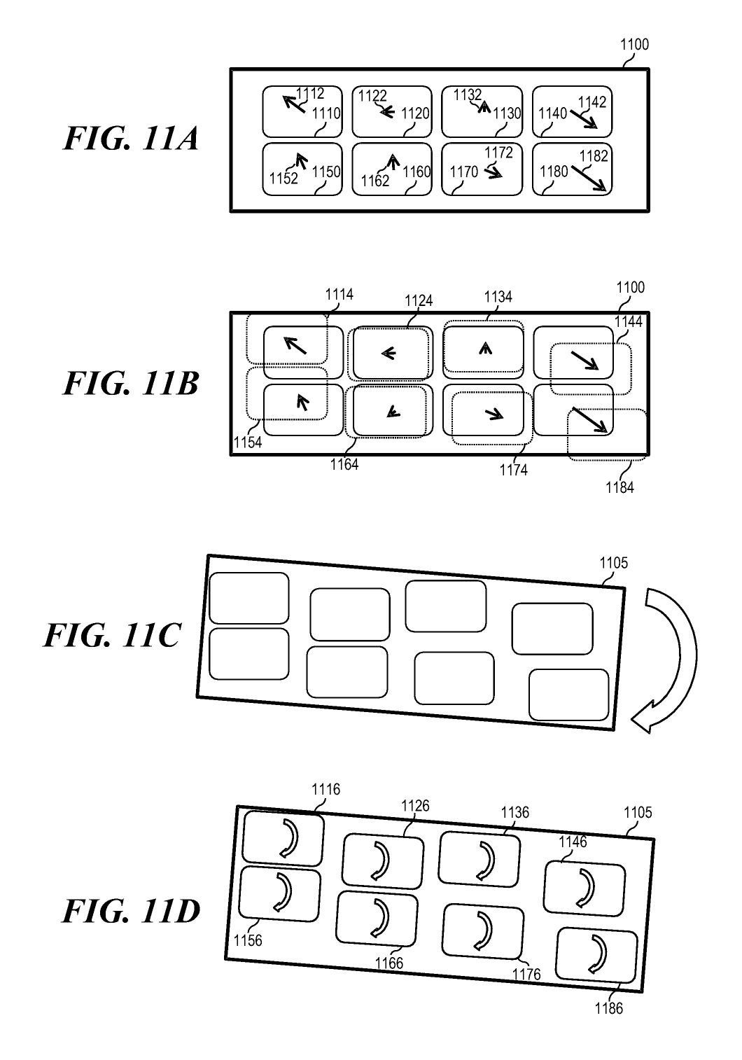

After shifting, rotation, and resizing of the portions, key rotating module 334 may then rotate each key individually to match the new orientation of the virtual keyboard. For example, key rotating module 334 may simply rotate each key in a given portion by the same degree of rotation used by portion rotating module 332 for the given portion. As a result, key rotating module 334 may modify the keyboard so that the angle of each key within a given portion matches the angle of the outline of the portion. An example of a technique for rotating individual keys is provided below in connection with FIGS. 11A-11D.

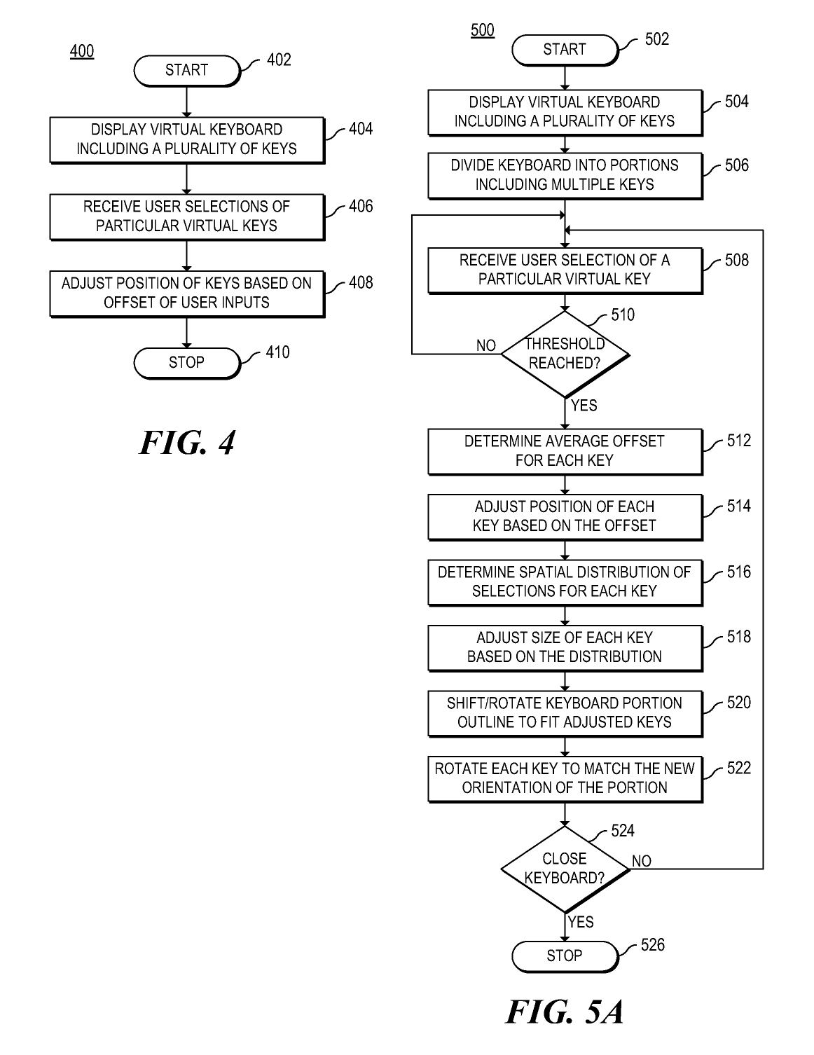

FIG. 4 is a flowchart of an example method 400 for adjusting keys of a virtual keyboard based on the offset of a user's input. Although execution of method 400 is described below with reference to computing device 200 of FIG. 2, other suitable devices for execution of method 400 will be apparent to those of skill in the art (e.g., computing device 300 of FIG. 3). Method 400 may be implemented in the form of executable instructions stored on a machine-readable storage medium, such as storage medium 220, and/or in the form of electronic circuitry.

Method 400 may start in block 402 and proceed to block 404, where computing device 200 may display a virtual keyboard including a plurality of keys. For example, computing device 200 may output a user interface of a keyboard that includes a number of keys individually selectable based on provision of touch input at the position of the key.

Next, in block 406, computing device 200 may receive user selections of a plurality of virtual keys on the virtual keyboard. For example, as the user is typing on the virtual keyboard by providing touch input to a touch-enabled display 215, computing device 200 may receive a notification of the coordinate of each touch. Computing device 200 may then process each input to determine the key on the virtual keyboard selected with each touch.

In block 408, computing device 200 may then adjust the position of the keys based on the offset of the user inputs, where the offset of each input is the distance and direction of the input from a given point on the corresponding key. In some implementations, computing device 200 may individually adjust the position of each key based on the inputs received for the given key. Alternatively, computing device 200 may adjust the position of a group of keys (e.g., a half of the keyboard or the entire keyboard) based on an aggregate offset for the keys in the group. After adjusting the keys as appropriate, method 400 may continue to block 410, where method 400 may stop.

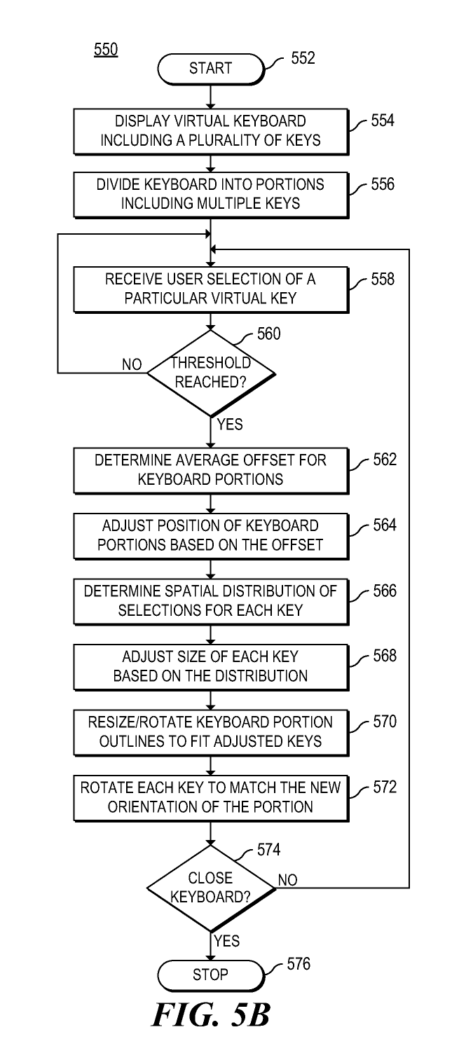

FIG. 5A is a flowchart of an example method 500 for individually adjusting keys of a virtual keyboard based on the offset of a user's inputs for each key. Although execution of method 500 is described below with reference to computing device 300 of FIG. 3, other suitable devices for execution of method 500 will be apparent to those of skill in the art. Method 500 may be implemented in the form of executable instructions stored on a machine-readable storage medium, such as storage medium 220, and/or in the form of electronic circuitry.

Method 500 may start in block 502 and proceed to block 504, where computing device 300 may output a virtual keyboard including a plurality of keys selectable with touch input provided to a touch-enabled display 305. Next, in block 506, computing device 300 may divide the keyboard into portions each including multiple keys. For example, computing device 300 may divide the keyboard into halves, quarters, or any other division of keys. In the description of method 500 that follows, however, it should be understood that the term “portion” may refer to the keyboard as a whole.

In block 508, computing device 300 may receive a selection of a particular key from a user. Next, in block 510, computing device 300 may determine whether an input threshold has been reached for adjusting the virtual keyboard. For example, computing device 300 may determine whether a minimum number of key selections have been received since the last adjustment of the keyboard.

If the input threshold has not yet been met, method 500 may return to block 508, where computing device 300 may continue to monitor for user selections of keys on the virtual keyboard. Otherwise, if the input threshold has been met, method 500 may proceed to block 512.

In block 512, computing device 300 may determine the average offset for the inputs received for each key. For example, for each input associated with a key in a given portion, computing device 300 may determine the distance and direction of a vector starting at a fixed position on the key (e.g., the center of the key) and ending at the coordinates of the input. Computing device 300 may then calculate an average offset for each key by averaging all of the offset vectors associated with the particular key. By repeating this procedure for each key of the virtual keyboard, computing device 300 may determine an average offset for each of the keys.

Next, in block 514, computing device 300 may adjust the position of each key based on the determined offset. For example, for each key, computing device 300 may shift the position of the key in the direction and magnitude of the average offset determined in block 512. As a result, computing device 300 may individually move each key based on the accuracy of the user's typing for each key.

In block 516, computing device 300 may then determine the spatial distribution of the user's selections for each key. As one example implementation, computing device 300 may identify the coordinates of each touch input associated with a given key and determine a minimal key size that would encompass all inputs. In block 518, computing device 300 may then adjust the size of each key to fit the spatial distribution determined in block 516.

After computing device 300 individually adjusts the position and size of each key, method 500 may proceed to block 520. In block 520, computing device 300 may adjust the size and position of each portion of the virtual keyboard, such that the outline of each portion fits the adjusted keys in the portion. For example, computing device 300 may shift, resize, and/or rotate the outline of each portion to ensure that the outline of the keyboard encompasses each of the keys. In block 522, computing device 300 may then rotate each key to match the new orientation of the corresponding portion. For example, computing device 300 may rotate each key in the same direction and by the same degree as the rotation of the corresponding portion.

After adjusting the position and size of each key, adjusting the outline of each portion, and rotating the keys as necessary, method 500 may proceed to block 524. In block 524, computing device 300 may determine whether the user has provided a command to close the keyboard, the display of the virtual keyboard has timed out, or device 300 otherwise determines that the keyboard is to be closed. If not, method 500 may return to block 508, where computing device 300 may await the user's next selection of a virtual key. Otherwise, if the keyboard is to be closed, computing device 300 may close the virtual keyboard and method 500 may stop in block 526.

FIG. 5B is a flowchart of an example method 550 for adjusting portions of a virtual keyboard based on the aggregate offset of the user's inputs for each portion. Although execution of method 550 is described below with reference to computing device 300 of FIG. 3, other suitable devices for execution of method 550 will be apparent to those of skill in the art. Method 550 may be implemented in the form of executable instructions stored on a machine-readable storage medium and/or in the form of electronic circuitry.

Method 550 may start in block 552 and proceed to block 554, where computing device 300 may output a virtual keyboard including a plurality of keys selectable with touch input. Next, in block 556, computing device 300 may divide the keyboard into portions each including multiple keys, such as halves or quarters. In the description of method 550 that follows, however, it should be understood that the term “portion” may refer to the keyboard as a whole.

In block 558, computing device 300 may receive a selection of a particular key from a user. Next, in block 560, computing device 300 may determine whether an input threshold has been reached for adjusting the virtual keyboard. For example, computing device 300 may determine whether a minimum number of key selections have been received since the last adjustment of the keyboard.

If the input threshold has not yet been met, method 550 may return to block 558, where computing device 300 may continue to monitor for user selections of keys on the virtual keyboard. Otherwise, if the input threshold has been met, method 550 may proceed to block 562.

In block 562, computing device 300 may determine the average offset for each keyboard portion. For example, for each input associated with a key in a given portion, computing device 300 may determine the distance and direction of a vector starting at a fixed position on the key (e.g., the center of the key) and ending at the coordinates of the user's input. Computing device 300 may then calculate an average offset for each portion by averaging all of the offset vectors for any keys contained in the portion. Computing device 300 may repeat this procedure for all portions to obtain an average offset for each of the portions.

Next, in block 564, computing device 300 may adjust the position of each portion based on the determined offset. For example, for each portion, computing device 300 may shift the position of each key in the portion in the direction and magnitude of the average offset determined in block 562.

In block 566, computing device 300 may then determine the spatial distribution of the user's selections for each key. As one example implementation, computing device 300 may identify the coordinates of each touch input associated with a given key and determine a minimal key size that would encompass all inputs. In block 568, computing device 300 may then adjust the size of each key to fit the spatial distribution determined in block 566.

After computing device 300 adjusts the position of the portions and the size of each key, method 550 may proceed to block 570. In block 570, computing device 300 may adjust the size and position of each portion of the virtual keyboard, such that the outline of each portion fits the adjusted keys in the portion. Then, in block 572, computing device 300 may rotate each key to match the new orientation of the corresponding portion. For example, computing device 300 may rotate each key in the same direction and by the same degree as the rotation of the corresponding portion.

After adjusting the position of each portion, resizing each key as necessary, adjusting the outline of each portion, and rotating the keys as necessary, method 500 may proceed to block 574. In block 574, computing device 300 may determine whether the keyboard is to be closed. If not, method 550 may return to block 558, where computing device 300 may await the user's next selection of a virtual key. Otherwise, if the keyboard is to be closed, computing device 300 may close the virtual keyboard and method 550 may stop in block 576.

FIGS. 6A to FIG. 12 are diagrams of various techniques for adjusting keys according to the offsets of the user's touch inputs. The following techniques may be implemented by, for example, computing device 200 of FIG. 2 or computing device 300 of FIG. 3. For example, the techniques may be implemented as a series of instructions encoded on a machine-readable storage medium and/or in the form of electronic circuitry. Additionally, although described below without respect to a subset of the keys of a keyboard or to keyboards with a limited number of keys, it should be understood that the techniques may be applied to all keys in a keyboard or to a keyboard with a greater number of keys.

FIGS. 6A-6D are diagrams of an example technique for adjusting the position of an individual virtual key based on an offset vector calculated for the key. As illustrated in FIG. 6A, the user has provided a series of inputs 605 to key 600 grouped in the upper-right hand corner of key 600. In response, in FIG. 6B, the computing device has identified a plurality of vectors 610 connecting the center of key 600 with each input 605. Next, as shown in FIG. 6C, the computing device has calculated an average offset vector 615, representing the average of each of the offset vectors 610. Finally, in FIG. 6D, the computing device has translated key 600 to a new position 620, such that the new position 620 is offset from the position of original key 600 in the direction and magnitude of average offset vector 615.

FIGS. 7A & 7B are diagrams of an example technique for adjusting the size of an individual virtual key based on a spatial distribution of the user inputs for the key. As illustrated in FIG. 7A, the user has provided a series of inputs 705 to key 700. The inputs are concentrated within region 710, which is a circle of the smallest diameter that encompasses all of the inputs 705. As a result, the computing device has determined that key 700 may be reduced in size while maintaining the aspect ratio of the key, as indicated by dotted lines 715. Thus, in FIG. 7B, the computing device has resized key 700 to the new key 720.

FIGS. 8A-8C are diagrams of an example technique for adjusting the position and size of multiple virtual keys based on the offset and distribution of the inputs for each key. As illustrated, a virtual keyboard includes keys 800, 810, 820, 830, 840, 850. The user has provided inputs 802 to key 800, inputs 812 to key 810, inputs 822 to key 820, inputs 832 to key 830, inputs 842 to key 840, and inputs 852 to key 850. In response, the computing device has calculated an average offset vector for each key, by determining the average offset of each of the inputs from the center of the corresponding key. Thus, the computing device has calculated offset vectors 804, 814, 824, 834, 844, and 854 as corresponding to the inputs provided to keys 800, 810, 820, 830, 840, and 850, respectively.

In FIG. 8B, the computing device has calculated new positions for each of the keys by shifting the position of each key and resizing each key according to the calculated average offsets and distribution of offsets. Thus, new positions 806, 816, 826, 836, 846, 856 correspond to the shifted locations and adjusted sizes of keys 800, 810, 820, 830, 840, and 850, respectively. In FIG. 8C, the computing device has moved each key to the new location and, as illustrated, each of keys 800, 810, 820, 830, 840, 850 now respectively corresponds to a shifted and resized key 808, 818, 828, 838, 848, 858.

FIGS. 9A-9C are diagrams of an example technique for adjusting the position of an entire virtual keyboard based on an aggregate offset of the inputs for the keyboard. As illustrated, in FIG. 9A, keyboard 900 includes keys 910, 920, 930, 940, 950, 960, 970, 980. The computing device has calculated an average input offset for each key, as represented by average offset vectors 912, 922, 932, 942, 952, 962, 972, 982. In FIG. 9B, the computing device has averaged each of the offset vectors to calculate an aggregate offset vector 990 and has calculated a new position of keyboard 905 representing keyboard 900 shifted in accordance with the offset vector 990. Finally, in FIG. 9C, the computing device has shifted keyboard 900 to new position 907.

FIGS. 10A-10C are diagrams of an example technique for adjusting the position of multiple virtual keyboard portions based on an aggregate offset of the inputs for each portion. As illustrated in FIG. 10A, a keyboard includes two halves, left half 1000 and right half 1050. Left half 1000 includes keys 1010, 1020, 1030, 1040, while right half 1050 includes keys 1060, 1070, 1080, 1090. In response to user inputs, the computing device has calculated offset vectors 1012, 1022, 1032, 1042 for left half 1000 corresponding to keys 1010, 1020, 1030, 1040. Similarly, the computing device has calculated offset vectors 1062, 1072, 1082, 1092 for right half 1050 corresponding to keys 1060, 1070, 1080, 1090.

In FIG. 10B, the computing device has calculated two offset vectors. A first offset vector 1002 represents the average of vectors 1012, 1022, 1032, 1042, while a second offset vector 1052 represents the average of vectors 1062, 1072, 1082, 1092. In FIG. 10C, the computing device has shifted each half 1000, 1050 according to the corresponding average offset vector 1002, 1052. Thus, the computing device has shifted first half 1000 in the direction and magnitude of vector 1002 to form a new left half 1004, while shifting second half 1050 in the direction and magnitude of vector 1052 to form a new right half 1054.

FIGS. 11A-11D are diagrams of an example technique for adjusting the position of multiple virtual keys and rotating the virtual keyboard to fit the new position of the keys. As illustrated in FIG. 11A, keyboard 1100 includes keys 1110, 1120, 1130, 1140, 1150, 1160, 1170, and 1180. In response to user inputs, the computing device has calculated offset vectors 1112, 1122, 1132, 1142, 1152, 1162, 1172, 1182 based on the inputs received for each key. In FIG. 11 B, the computing device has calculated new key positions 1114, 1124, 1134, 1144, 1154, 1164, 1174, 1184 for each key by shifting each key in the direction and magnitude of the corresponding offset vector.

In FIG. 11C, the computing device has rotated the outline of keyboard 1100 in a clockwise direction so that the outline encompasses each of the shifted keys. Thus keyboard 1100 is now in a new position 1105. Furthermore, as shown in FIG. 11D, the computing device has also rotated each of the keys in a clockwise direction by the same degree of the rotation of keyboard 1105. Thus, each of the keys is now in a rotated position 1116, 1126, 1136, 1146, 1156, 1166, 1176, 1186.

FIGS. 12A-12C are diagrams of an example technique for adjusting the position of each column of virtual keys within a portion and rotating each portion to fit the adjusted columns. As illustrated in FIG. 12A, a virtual keyboard includes two halves, a left half 1200 and a right half 1250. Left half 1200 includes keys 1210, 1220, 1230, 1240, while right half 1250 includes keys 1260, 1270, 1280, 1290. In response to user inputs, the computing device has calculated offset vectors 1212, 1222, 1232, 1242 for left half 1200 and calculated offset vectors 1262, 1272, 1282, 1292 for right half 1250.

In FIG. 12B, the computing device has calculated average offset vectors for each column in each half of the virtual keyboard. Thus, for left half 1200, the computing device has calculated offset vector 1214 representing the average of vectors 1212 and 1232 and offset vector 1224 representing the average of vectors 1222 and 1242. Similarly, for right half 1250, the computing device has calculated offset vector 1264 representing the average of vectors 1262 and 1282 and offset vector 1274 representing the average of vectors 1272 and 1292.

Furthermore, the computing device has calculated a new position 1202 for left half 1200 and a new position 1204 for right half 1250. To determine new position 1202, the computing device has shifted the left portion of left half 1200 by offset vector 1214 and the right portion of left half 1200 by offset vector 1224. Similarly, to determine new position 1204, the computing device has shifted the left portion of right half 1250 by offset vector 1264 and shifted the right portion of right half 1250 by offset vector 1274. Thus, as illustrated in FIG. 12C, the computing device has moved left half 1200 to new position 1202 and moved right half 1250 to new position 1204. In doing so, the computing device has rotated left half 1202 in accordance with the angle formed between the endpoint of vector 1224 and the endpoint of vector 1214. Similarly, the computing device has rotated right half 1204 in accordance with the angle formed between the endpoint of vector 1264 and the endpoint of vector 1274.

The foregoing disclosure describes a number of example embodiments for dynamically shifting keys of a virtual keyboard. In particular, example embodiments shift the location of keys of a virtual keyboard and/or resize the keys as a user types in accordance with the offset of the user's touch inputs from a given location on the keys. As a result, example embodiments enable a user to type using a virtual keyboard with increased speed and accuracy regardless of the form factor of the touch-enabled device. Additional embodiments and advantages of such embodiments will be apparent to those of skill in the art upon reading and understanding the foregoing description.

We claim:

1. A computing device comprising:
a touch-enabled display; and
a processor to:
display a virtual keyboard on the touch-enabled display, the virtual keyboard including a plurality of virtual keys selectable based on input provided to the touch-enabled display;
receive a plurality of user inputs provided to the touch-enabled display, each user input corresponding to a selection of a particular virtual key of the plurality of virtual keys, and
adjust a position of at least a first virtual key based on an offset with respect to the first virtual key of each user input corresponding to the first virtual key.

2. The computing device of claim 1, wherein the processor is additionally to:
adjust the position of the first virtual key based on the offset of each user input corresponding to the first virtual key from a center coordinate of the first virtual key.

3. The computing device of claim 2, wherein the processor is additionally to:
adjust the position of the first virtual key according to an average vector calculated from vectors formed between the center coordinate and a coordinate of each user input corresponding to the first virtual key.

4. The computing device of claim 1, wherein the processor is additionally to:
increase or decrease a size of the first virtual key based on a spatial distribution of the user inputs corresponding to the first virtual key.

5. The computing device of claim 1, wherein the processor is to adjust the position of at least the first virtual key based upon a predetermined number of most recent user inputs.

6. The computing device of claim 1, wherein the processor is additionally to:
adjust a position of each remaining virtual key, wherein the adjusted position for a particular virtual key is based on an offset of each user input corresponding to the particular virtual key.

7. The computing device of claim 1, wherein, to adjust the position of at least the first virtual key, the processor is to:
shift a position of the virtual keyboard based on an average offset of each of the plurality of user inputs from the corresponding virtual keys.

8. The computing device of claim 7, wherein the processor is additionally to:
shift a position of a first portion of the virtual keyboard based on the average offset for virtual keys included in the first portion, and
shift a position of a second portion of the virtual keyboard based on an average offset for virtual keys included in the second portion.

9. The computing device of claim 1, wherein the processor is additionally to:
rotate an outline of the virtual keyboard to a new orientation to fit the adjusted position of at least the first virtual key.

10. The computing device of claim 9, wherein the processor is additionally to:
rotate each virtual key individually to match the new orientation of the outline of the virtual keyboard.

11. A non-transitory machine-readable storage medium encoded with instructions executable by a processor of a computing device for adjusting a virtual keyboard, the machine-readable storage medium comprising:
instructions for displaying a virtual keyboard including a plurality of virtual keys selectable based on touch input;
instructions for receiving a plurality of user inputs, each user input corresponding to a selection of a particular virtual key of the plurality of virtual keys; and
instructions for adjusting a position of each virtual key, wherein the adjusted position for a particular virtual key is determined based at least on an offset of the user inputs corresponding to the particular virtual key with respect to a predetermined position on the particular virtual key.

12. The non-transitory machine-readable storage medium of claim 11, wherein the instructions for adjusting are configured to adjust the position of each virtual key individually based on the offset of the user inputs corresponding to the virtual key.

13. The non-transitory machine-readable storage medium of claim 11, wherein the instructions for adjusting are configured to adjust the position of the virtual keyboard as a whole based on an average offset of the plurality of user inputs.

14. A method comprising:
displaying, by a computing device, a virtual keyboard including a plurality of virtual keys selectable with touch input;
receiving a plurality of user inputs, each user input corresponding to a selection of a particular virtual key of the plurality of virtual keys;
determining a plurality of offsets, wherein each offset is based on a distance of a particular user input from a predetermined position on the corresponding virtual key; and
adjusting the position of each virtual key on the virtual keyboard based on the determined plurality of offsets.

15. The method of claim 14, wherein the adjusting comprises moving the entire virtual keyboard according to an average offset of the plurality of offsets.
